(19) United States
(12) Patent Application Publication
(10) Pub. No.: US 2011/0285806 A1
(43) Pub. Date: Nov. 24, 2011

(54) RECORDING AND REPRODUCING APPARATUS

(75) Inventor: Kazuyuki Shirai, Shijonawate City (JP)

(73) Assignee: SANYO ELECTRIC CO., LTD., Osaka (JP)

(21) Appl. No.: 13/110,499

(22) Filed: May 18, 2011

(30) Foreign Application Priority Data
May 18, 2010 (JP) 2010-114144

(51) Int. Cl. H04N 7/14

(52) U.S. Cl. 348/14.01; 348/E07.077

(57) ABSTRACT

A recording and reproducing apparatus includes at least one of a camera and a microphone so that at least one of video information obtained by the camera and sound information obtained by the microphone is recorded as message information, a reproducing unit which reproduces the message information, a designated time receiving unit which receives designation of time, and a person distinguishing unit which distinguishes presence or absence of a person. The reproducing unit performs the reproduction in accordance with the designated time and a distinction result of the person distinguishing unit.

### CROSS-REFERENCE TO RELATED APPLICATIONS

This nonprovisional application claims priority under 35 U.S.C. §119(a) on Patent Application No. 2010-114144 filed in Japan on May 18, 2010, the entire contents of which are hereby incorporated by reference.

### BACKGROUND OF THE INVENTION

1. Field of the Invention

The present invention relates to a recording and reproducing apparatus which records and reproduces video information and sound information.

2. Description of Related Art

Conventionally, apparatuses such as a video camera or a voice recorder are widely used for recording video information or sound information and for reproducing the recorded information. Using such a recording and reproducing apparatus, it is possible to record important video information or sound information and later to reproduce the information for confirming the contents thereof.

In addition, there is considered a recording and reproducing apparatus that has a function of automatically reproducing recorded information at a scheduled playback time designated by a user in advance (hereinafter referred to as “automatic reproduction function” for convenience sake). The recording and reproducing apparatus having the automatic reproduction function is suitable for means for sending and receiving message with a time difference.

Here, it is supposed that a user (sender of a message) intends to give a message to another user (receiver of a message) using the recording and reproducing apparatus having the automatic reproduction function. In this case, the sender of a message records video and/or sound (figure and/or voice of himself or herself) expressing the message using the recording and reproducing apparatus, and sets the scheduled playback time at which the sender of the message wants the receiver to receive the message.

In this way, the message information is reproduced at the scheduled playback time so that the receiver can receive the message at the time desired by the sender of the message. Note that because the message information is automatically reproduced, the message is given to the receiver as long as the receiver exists near the recording and reproducing apparatus at the scheduled playback time.

As described above, the recording and reproducing apparatus having the automatic reproduction function is convenient for sending and receiving a message with a time difference. However, the receiver of the message may not be near the recording and reproducing apparatus at the scheduled playback time. In this case, although the message information is reproduced at the scheduled playback time, the message is overlooked or failed to hear, namely is not transmitted to the receiver.

In this case, it is usually desirable that the message information is promptly reproduced later when the receiver of the message appears there. In this way, it is desired that the reproduction of the message information is performed in accordance with the scheduled time as well as presence or absence of the person (receiver of the message).

### SUMMARY OF THE INVENTION

A recording and reproducing apparatus according to the present invention has at least one of a camera and a microphone so as to record at least one of video information obtained by the camera and sound information obtained by the microphone as message information. The recording and reproducing apparatus includes a reproducing unit which reproduces the message information, a designated time receiving unit which receives designation of time, and a person distinguishing unit. The reproducing unit performs the reproduction in accordance with the designated time and a distinction result of the person distinguishing unit.

### BRIEF DESCRIPTION OF THE DRAWINGS

Objects and features of the present invention will be more apparent from the following description of a preferred embodiment with reference to the attached drawings, which is as below.

FIG. 1 is an outline diagram of a recording and reproducing apparatus according to an embodiment of the present invention.

FIG. 2 is a block diagram illustrating a structure of the recording and reproducing apparatus.

FIG. 3 is a flowchart illustrating an action concerning transmission and reception of a message.

FIG. 4 is a flowchart illustrating a recording action of a message.

FIG. 5 is a flowchart illustrating a reproduction waiting action.

FIG. 6 is an explanatory diagram concerning a use of a communication system.

FIG. 7 is an explanatory diagram concerning the communication system.

### DETAILED DESCRIPTION OF THE PREFERRED EMBODIMENTS

An embodiment of the present invention will be described with reference to an example of a recording and reproducing apparatus for recording and reproducing message information, which also has a function as a television broadcasting receiver.

[About Structure of the Recording and Reproducing Apparatus]

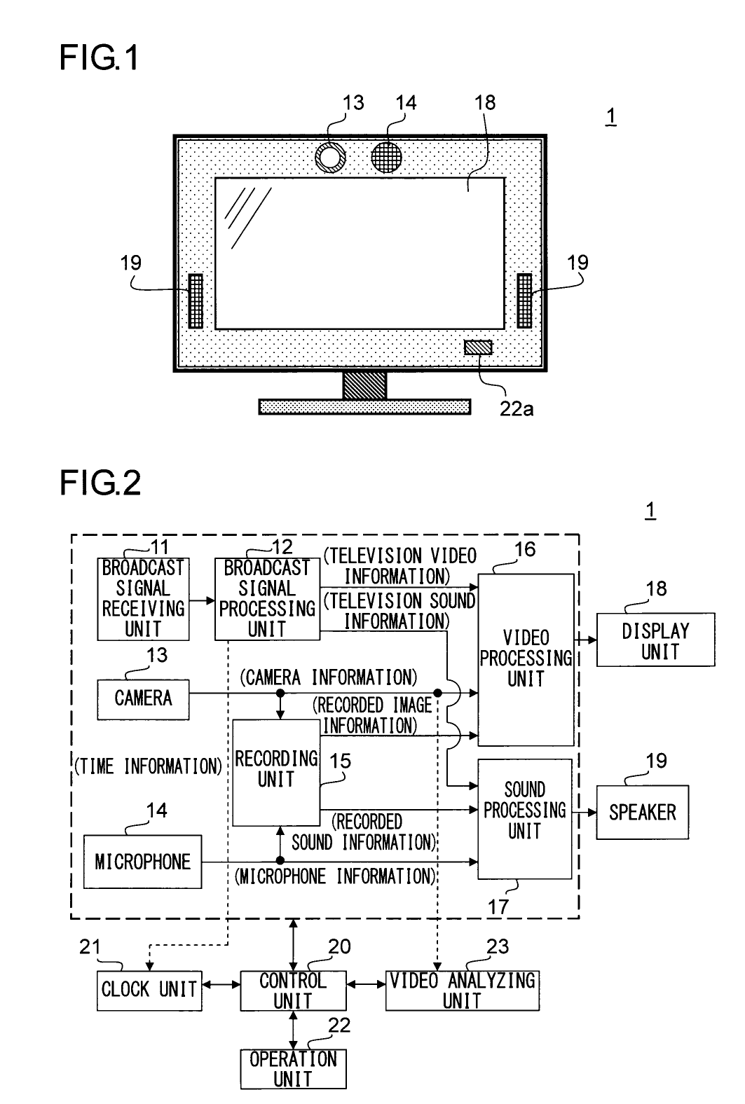

FIG. 1 illustrates an outline diagram of the recording and reproducing apparatus according to this embodiment (front view of the recording and reproducing apparatus). FIG. 2 illustrates a block diagram of the recording and reproducing apparatus according to this embodiment.

As illustrated in these diagrams, the recording and reproducing apparatus 1 includes a broadcast signal receiving unit 11, a broadcast signal processing unit 12, a camera 13, a microphone 14, a recording unit 15, a video processing unit 16, a sound processing unit 17, a display unit 18, a speaker 19, a control unit 20, a clock unit 21, an operation unit 22, a video analyzing unit 23, and the like. The recording and reproducing apparatus 1 is installed for use in a living room or the like of each home as a household television broadcasting receiver, for example.

The broadcast signal receiving unit 11 is constituted of an antenna (or an input terminal of a broadcast signal), a tuner, and the like, and has a function of receiving television broadcast. A broadcasting channel selected by the tuner is controlled by the control unit 20. Note that the television broadcast signal received by the broadcast signal receiving unit 11 contains video information and sound information of a television program as well as present time information like a digital ground broadcast signal.

The broadcast signal processing unit 12 receives the broadcast signal received by the broadcast signal receiving unit 11. Then, the broadcast signal processing unit 12 extracts television video information indicating video of the television program, television sound information indicating sound of the television program, and time information indicating present time from the received broadcast signal.

In other words, the broadcast signal processing unit 12 has a role of extracting each of the information from the broadcast signal in which a plurality of information pieces are multiplexed. The television video information is sent to the video processing unit 16, the television sound information is sent to the sound processing unit 17, and the time information is sent to the clock unit 21.

The camera 13 is constituted of a lens, an image sensor, and the like, so as to take a moving image of a subject in accordance with an instruction from the control unit 20. The lens of the camera 13 is disposed on the front surface of the recording and reproducing apparatus 1 as illustrated in FIG. 1, so that the front area of the recording and reproducing apparatus 1 becomes a subject. The moving image information obtained by the camera 13 (hereinafter referred to as “camera information” for convenience sake) is sent to the recording unit 15, the video processing unit 16, and the video analyzing unit 23.

The microphone 14 has a function of converting sound (air vibration) into an electric signal so as to obtain sound information in accordance with an instruction from the control unit 20. The microphone 14 is disposed on the front surface of the recording and reproducing apparatus 1 as illustrated in FIG. 1, so that information of sound from the front area of the recording and reproducing apparatus 1 (particularly a human voice is assumed) can be obtained easily. The sound information obtained by the microphone 14 (hereinafter referred to as “microphone information” for convenience sake) is sent to the recording unit 15 and the sound processing unit 17.

The recording unit 15 is constituted of a hard disk drive (HDD) so as to record the camera information and the microphone information in accordance with an instruction from the control unit 20. For convenience sake of description, the camera information recorded in the recording unit 15 is referred to as “recorded image information”, and the microphone information recorded in the recording unit 15 is referred to as “recorded sound information” in the following description. The recorded image information and the recorded sound information are sent to the video processing unit 16 and the sound processing unit 17, respectively, in accordance with an instruction from the control unit 20.

The video processing unit 16 generates an output video signal for the display unit 18 to display the video and sends the signal to the display unit 18. The video processing unit 16 can receive the television video information, the camera information, and the recorded image information from the broadcast signal processing unit 12, the camera 13, and the recording unit 15, respectively. The video processing unit 16 uses these information pieces selectively for generating the output video signal in accordance with an instruction from the control unit 20.

The sound processing unit 17 generates an output sound signal for the speaker 19 to output sound and sends the signal to the speaker 19. The sound processing unit 17 can receive the television sound information, the microphone information, and the recorded sound information from the broadcast signal processing unit 12, the microphone 14, and the recording unit 15, respectively. The sound processing unit 17 uses these information pieces selectively for generating the output sound signal in accordance with an instruction from the control unit 20.

The display unit 18 is constituted of a liquid crystal display or a plasma display, for example, so as to display video based on the received output video signal. The display unit 18 is disposed on the front surface of the recording and reproducing apparatus 1 as illustrated in FIG. 1. Thus, the video is displayed for a user (viewer) existing in front of the recording and reproducing apparatus 1.

The speaker 19 generates sound based on the received output sound signal. The speaker 19 is disposed on the front surface of the recording and reproducing apparatus 1 as illustrated in FIG. 1. Thus, the sound is output to a user (viewer) existing in front of the recording and reproducing apparatus 1.

The control unit 20 is constituted of a CPU, for example, which controls individual units so that the recording and reproducing apparatus 1 works normally. Note that main actions of the recording and reproducing apparatus 1 will be described later.

The clock unit 21 has a clock function of counting present time. In addition, the clock unit 21 appropriately corrects a count error based on the time information received from the broadcast signal processing unit 12.

Note that the clock unit 21 may not have the function of counting time by itself but may have a function of receiving latest time information continuously so as to grasp the present time. In any case, the clock unit 21 grasps the present time based on time information contained in the television broadcast signal. The present time information obtained by the clock unit 21 is sent to the control unit 20.

The operation unit 22 is constituted of a remote control device (transmitter and receiver of a remote control signal) for receiving remote control by a user, and button switches or the like operated by the user. The operation unit 22 receives various operations by the user via a user interface of them.

The information of operation by the operation unit 22 (reflected by the user's intention) is sent sequentially to the control unit 20. Supposing that the user exists in front of the recording and reproducing apparatus 1, a light receiving window 22a for receiving the remote control signal (for example, infrared rays) is disposed on the front surface of the recording and reproducing apparatus 1 as illustrated in FIG. 1.

The video analyzing unit 23 analyzes the video of the camera information received from the camera 13 so as to distinguish presence or absence of a person near the recording and reproducing apparatus 1. More specifically, the video analyzing unit 23 detects a difference between frames of the video and distinguishes whether or not the difference has reached a predetermined threshold value (namely, whether or not a movement of the subject has reached a reference level). Then, if the movement of the subject has reached a reference level, the video analyzing unit 23 distinguishes whether or not colors of the part having the movement in the video include a color close to skin color (color in a predetermined range).

Here, if a color close to skin color is included, it is considered that the part having the movement in the video is an image of a person (namely, a person exists near the recording and reproducing apparatus 1). Therefore, if a color close to skin color is included, the video analyzing unit 23 decides that a person exists near the recording and reproducing apparatus 1, and otherwise decides that a person does not exist. In this way, the video analyzing unit 23 checks a movement and color in the video for distinguishing whether or not the subject includes a human image, so as to distinguish presence or absence of a person.

However, other methods may be adopted as the method for distinguishing presence or absence of a person by the video analyzing unit 23. For instance, as the method for distinguishing whether or not the subject includes a human image, it is possible to adopt a pattern matching method in which a face of a person is noted.

[About Action of Recording and Reproducing Apparatus]

The main power of the recording and reproducing apparatus 1 can be turned on and off by operation of the operation unit 22, and the television broadcasting can be received when the main power is turned on. In other words, the recording and reproducing apparatus 1 receives the television broadcasting continuously and provides information of the television program to a viewer via the display unit 18 and the speaker 19. Note that tuning of the reception channel, sound level adjustment, and the like are performed appropriately in accordance with the operation of the operation unit 22.

On the other hand, when the main power is turned off, the recording and reproducing apparatus 1 stops to work so as to reduce power consumption as much as possible, except for some necessary functions (reception of switching of the main power, count of present time, and the like). In other words, the recording and reproducing apparatus 1 becomes a so-called stand-by state, in which the action of receiving television broadcasting is also stopped.

In addition, while the recording and reproducing apparatus 1 is receiving television broadcasting, the camera 13 and the video analyzing unit 23 work continuously, so as to monitor presence or absence of a person. If the state of absence of a person continues for a certain period of time (for example, 30 minutes) or longer, the main power is automatically turned off. Thus, the recording and reproducing apparatus 1 can reduce wasteful power consumption due to forgetting to shut off the television, as much as possible.

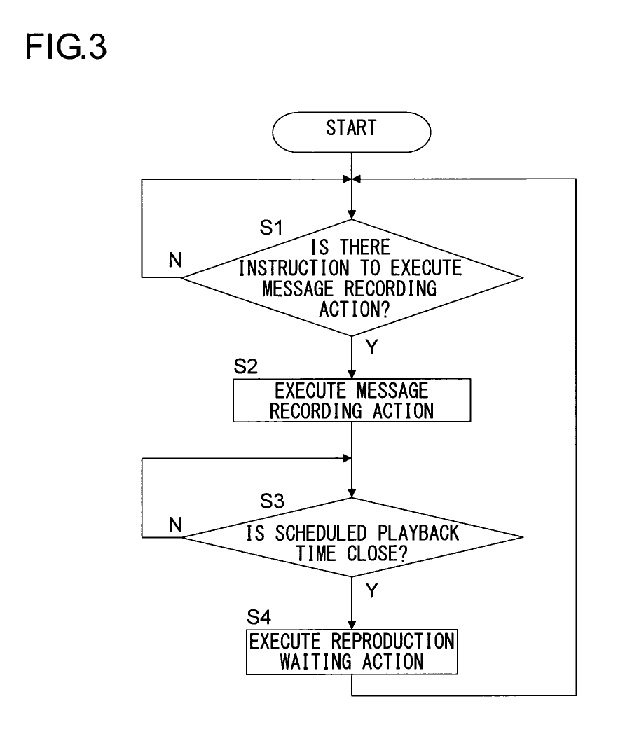

In addition, the recording and reproducing apparatus 1 can be also used as means for sending and receiving a message between users (sender and receiver of a message), like means similar to a message memo. A flow of the actions of the recording and reproducing apparatus 1 to work as the means for sending and receiving a message will be described below with reference to the flowcharts illustrated in FIGS. 3 to 5.

The recording and reproducing apparatus 1 continuously monitors whether or not an instruction to execute the message recording action (a predetermined operation of the operation unit 22) has been issued in a period while the main power is turned ON (Step S1). Note that this monitoring may be performed also in a period while the main power is turned off. When the instruction has issued (Y in Step S1), the recording and reproducing apparatus 1 performs the message recording action (Step S2).

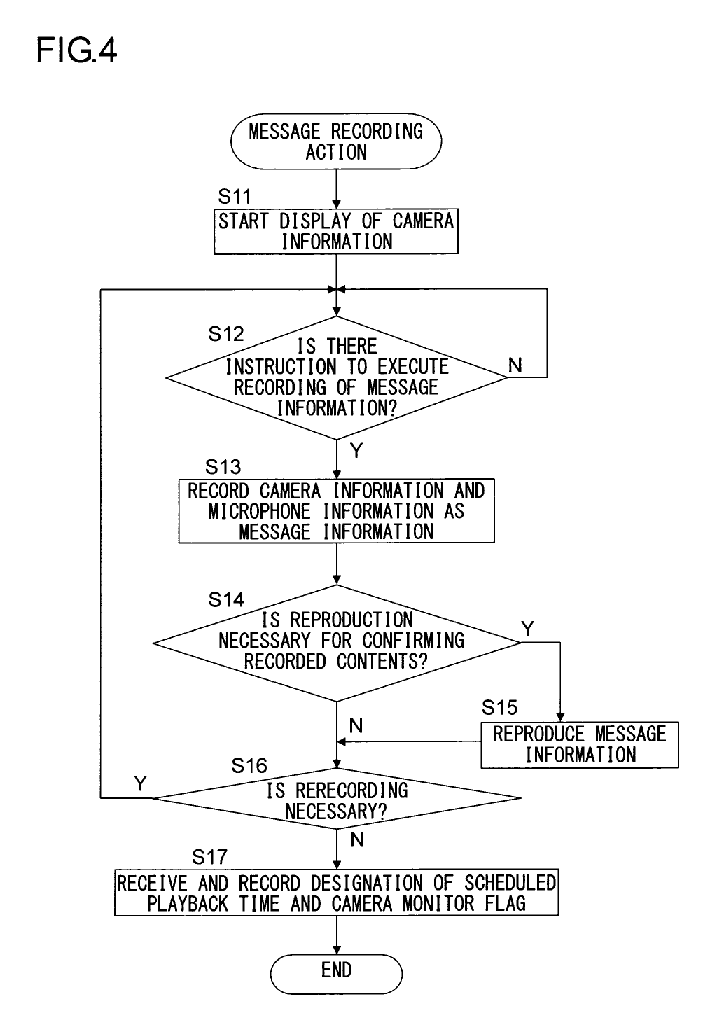

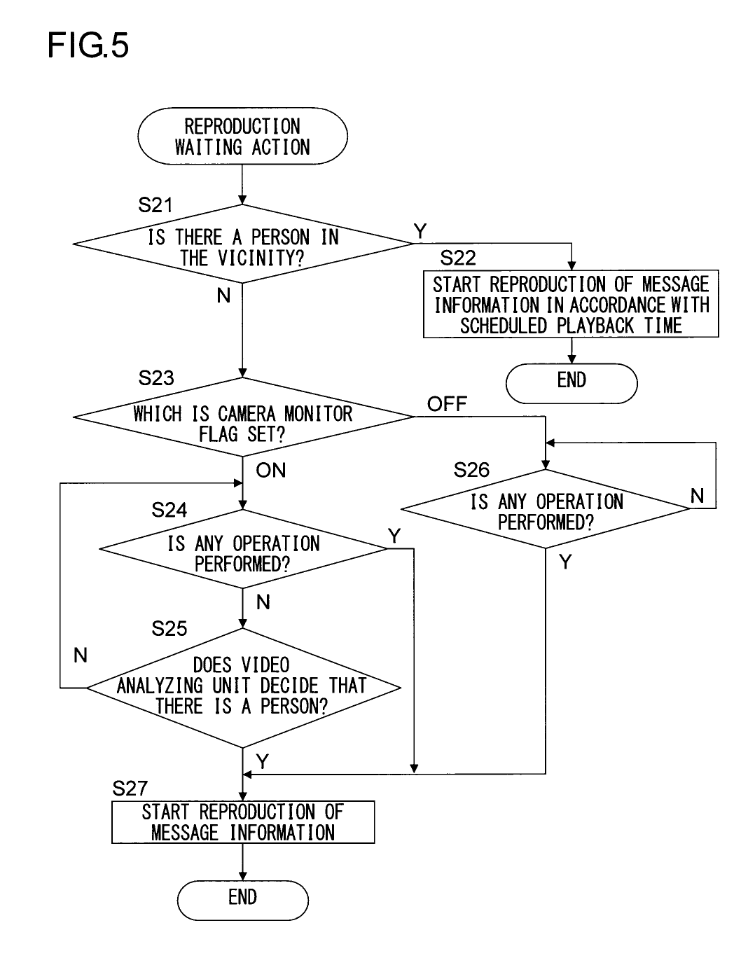

Thus, the user as a sender of a message can set the recording and reproducing apparatus 1 to start the message recording action. This message recording action is an action for realizing recording and the like of message information. Here, a flow of the message recording action will be described in more detail with reference to FIG. 4.

First, the recording and reproducing apparatus 1 starts a display of the camera information on the display unit 18 (real time display of a subject) (Step S11). Thus, the user as a sender of a message can check contents of the subject (for example, whether or not his or her own face is positioned in the middle of the subject).

Note that the region where the camera information is displayed may be the entire region of the display unit 18 or a part of the same when the display unit 18 is divided into a plurality of regions. In this case, video of a television program may be displayed in other region. In addition, if the display unit 18 can display an electronic program guide of television broadcasting, it is possible to display the camera information in a predetermined display window provided to the program guide. In addition, it is possible to prepare a plurality of display patterns concerning the form of the region where the camera information is displayed, and to adopt one of the patterns that is selected by the user.

In addition, the recording and reproducing apparatus 1 waits for an instruction to execute recording of message information (predetermined operation of the operation unit 22) (Step S12). In this case, the display unit 18 may display a message indicating that the instruction is being waited. When the instruction is issued (Y in Step S12), the recording and reproducing apparatus 1 records the camera information and the microphone information as the message information in the recording unit 15 (Step S13).

More specifically, the camera information and the microphone information obtained after the instruction to execute recording is issued until the instruction to stop recording is issued (or until a predetermined period of time passes) are associated to be synchronized with each other and are recorded as one message information. In this case, the display unit 18 may display a message indicating that the message information is being recorded.

Thus, the user as a sender of a message can set the recording and reproducing apparatus 1 to record video indicating the message (for example, video displaying his or her own face expression or gesture) and sound (for example, sound saying words of the message) as the message information.

After the recording of message information is completed, the recording and reproducing apparatus 1 waits for an instruction about whether it is necessary or not to reproduce the message information for confirming the recorded contents (predetermined operation of the operation unit 22) (Step S14). In this case, the display unit 18 may display a message indicating that the instruction is being waited.

When the instruction indicating that it is necessary is issued (Y in Step S14), the recording and reproducing apparatus 1 reproduces the message information recorded this time (Step S15). Thus, the user as a sender of a message can confirm the recorded contents as necessary. Note that when the instruction indicating that it is not necessary is issued (N in Step S14), reproduction of the message information is omitted.

After that, the recording and reproducing apparatus 1 waits for an instruction about whether it is necessary or not to rerecord of the message information (predetermined operation of the operation unit 22) (Step S16). In this case, the display unit 18 may display a message indicating that the instruction is being waited.

When the instruction indicating that the rerecording is necessary is issued (Y in Step S16), the recording and reproducing apparatus 1 repeats the action after the Step S12. Thus, the message information can be rerecorded, so that the newly recorded message information becomes valid. Note that the old message information may be abandoned.

On the other hand, if an instruction indicating that the rerecording is not necessary is issued (N in Step S16), the recording and reproducing apparatus 1 waits for designation of “scheduled playback time” and “camera monitor flag” (predetermined operation of the operation unit 22), and records the designated contents (Step S17). Note that the display unit 18 may display a message indicating that the designation is being waited during the waiting period.

Here the “scheduled playback time” is scheduled time to reproduce the message information that is recorded this time. A user as the sender of a message can designate the time when the message should be given to another user as the receiver of a message, as the scheduled playback time. Note that it is possible to directly input the time, or to input information of hours after the present time as the form of the designation.

In addition, the “camera monitor flag” can be set to “ON” or “OFF”. How the camera monitor flag is reflected on the action of the recording and reproducing apparatus 1 will be apparent from the description that will be given later. When the designated contents of the scheduled playback time and the camera monitor flag are recorded, the series of message recording action is completed.

With reference to FIG. 3 again, when the message recording action is completed, the recording and reproducing apparatus 1 continuously monitors whether or not the present time has become close to the scheduled playback time, regardless of a state of the main power (Step S3). More specifically, when a difference between the scheduled playback time and the present time becomes smaller than a period of time that is used for distinguishing presence or absence of a person and preparation for reproducing the message information (for example, approximately one minute), it is regarded that the present time has become close to the scheduled playback time.

When the present time has become close to the scheduled playback time (Y in Step S3), the recording and reproducing apparatus 1 starts a reproduction waiting action (Step S4). This reproduction waiting action is an action for reproducing the message information at a desired timing. Here, a process flow of the reproduction waiting action will be described in more detail with reference to FIG. 5.

First, the recording and reproducing apparatus 1 distinguishes presence or absence of a person in the vicinity of the apparatus (Step S21). More specifically, the camera 13 takes images of the subject for a predetermined period of time (e.g., for approximately 10 seconds), and the video analyzing unit 23 distinguishes presence or absence of a person based on the obtained camera information.

However, even if the video analyzing unit 23 decides that there is no person, if a certain operation has been performed by the operation unit 22 for the predetermined period of time, it is considered that there is actually a person in the vicinity of the apparatus. Therefore, in this case, it is decided that there is a person.

In other words, the control unit 20 obtains both the information of the above-mentioned distinction result by the video analyzing unit 23 and the information about presence or absence of operation by the operation unit 22. Then the control unit 20 finally decides presence or absence of a person by taking the information into consideration comprehensively.

If it is decided that there is a person (Y in Step S21), the recording and reproducing apparatus 1 starts reproduction of the message information when the present time reaches the scheduled playback time (in accordance with the scheduled playback time) (Step S22). In other words, the recording and reproducing apparatus 1 reproduces the recorded image information and the recorded sound information recorded in the recording unit 15 as the message information, via the display unit 18 and the speaker 19, respectively.

Note that the region where the message information is displayed may be the entire region of the display unit 18 or a part of the display unit 18 that is divided into a plurality of regions. In this case, video of a television program may be displayed in the other region. When the reproduction is completed, the reproduction waiting action is finished, and the action of the recording and reproducing apparatus 1 goes back to Step S1.

Thus, the message can be transmitted to a person (receiver of a message) who is in the vicinity of the recording and reproducing apparatus 1 at the scheduled playback time (at desired time designated by the sender of a message). However, if the person does not exist in the vicinity, even if the message information is reproduced, it is considered that the message can not be transmitted by overlooking or being failed to hear.

Therefore, if it is decided that there is no person (N in Step S21), the recording and reproducing apparatus 1 starts to monitor whether or not a person is in the vicinity of the apparatus without reproducing the message information. In this case, the recording and reproducing apparatus 1 first decides whether the camera monitor flag is set to ON or OFF (Step S23), so that the procedure of the monitoring is changed in accordance with a result of the decision.

Specifically, if the flag is set to ON (ON in Step S23), the recording and reproducing apparatus 1 starts to monitor whether or not a certain operation has been performed by the operation unit 22 (Step S24) and whether or not the video analyzing unit 23 has decided that there is a person (Step S25). In this case, the camera 13 continuously obtains the camera information and sends it to the video analyzing unit 23, so that the video analyzing unit 23 repeatedly performs the distinction about presence or absence of a person using the received camera information.

On the other hand, if the flag is set to OFF (OFF in Step S23), the recording and reproducing apparatus 1 starts monitoring whether or not any operation is performed by the operation unit 22 (Step S26). Note that if any operation is performed (Y in Step S24, Y in Step S26), or if the video analyzing unit 23 decides that there is a person (Y in Step S25), it is considered that the situation has occurred where a person exists in the vicinity of the recording and reproducing apparatus 1.

When the situation where a person exists has occurred, the recording and reproducing apparatus 1 reproduces the message information promptly (Step S27). Thus, it is possible to transmit the message to the person existing in the vicinity of the recording and reproducing apparatus 1 (receiver of a message) without delay from the scheduled playback time (desired time designated by the sender of a message) as much as possible.

When the reproduction is completed, the reproduction waiting action is finished, and the action of the recording and reproducing apparatus 1 goes back to Step S1. Note that as described above, monitoring with the camera 13 and the video analyzing unit 23 is performed when the camera monitor flag is ON, while such monitoring is omitted when the flag is OFF.

Therefore, when the camera monitor flag is ON, accuracy of the monitoring whether or not the situation where a person exists has occurred is enhanced than the case where the flag is OFF. On the other hand, if the camera monitor flag is OFF, power consumption and a load of process necessary for the monitoring can be reduced compared with the case where the flag is ON.

According to the reproduction waiting action as described above, the message information is reproduced if the present time has reached the scheduled playback time (namely, at the scheduled playback time or after the time), and if it is decided that there is a person in the vicinity of the recording and reproducing apparatus 1. As a result, the message can be transmitted to the receiver of a message as securely as possible and without delay from the desired time as much as possible.

In addition, according to the reproduction waiting action, even if the present time has reached the scheduled playback time, the reproduction of the message information is not performed until it is decided that there is a person. As a result, it is possible to suppress wasteful reproduction of the message information, so that a load of process and power consumption in the recording and reproducing apparatus 1 can be reduced as much as possible.

Note that the recording and reproducing apparatus 1 can be used for transmission and reception of a message in various situations. For instance, if the recording and reproducing apparatus 1 is installed in a living room or the like of a house, it is suitable for transmission and reception means of messages among family members.

[About Use of Communication System]

In addition, the recording and reproducing apparatus 1 may be connected to a certain communication system so that communication between the apparatus 1 and other equipment that is connected to the communication system can be performed. Thus, it is possible to further enhance convenience of the recording and reproducing apparatus 1.

For instance, the recording and reproducing apparatus 1 may have a function of being connected to Skype (TM) system (hereinafter referred to as “Skype system”) that is a type of voice over internet protocol (VoIP) communication system, so as to perform communication by utilizing the communication system.

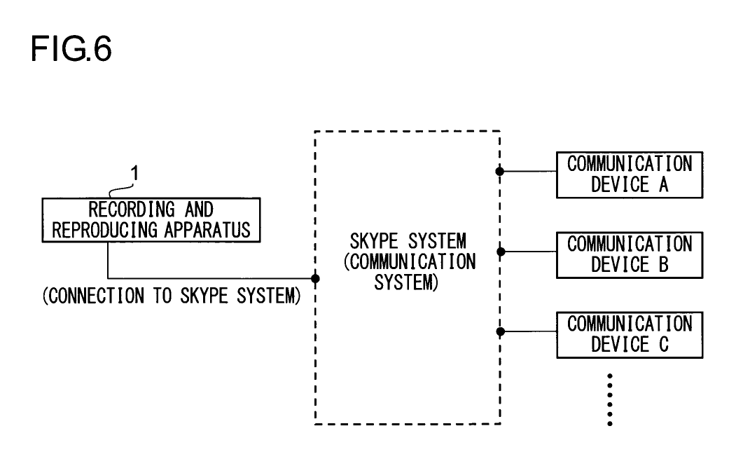

Thus, the recording and reproducing apparatus 1 can be connected to the communication system of Skype system as illustrated in FIG. 6 and can communicate with each of other communication devices (communication devices A to C are exemplified in FIG. 6) that are connected to this communication system.

In addition, as a result, a user of the recording and reproducing apparatus 1 can communicate with users of other communication devices connected to the Skype system. Note that the Skype system is known as a communication system that enables sound communication and video communication between users via the Internet.

Note that the recording and reproducing apparatus 1 may use the Skype system for transmitting the camera information and the microphone information (or one of them) to other communication device in accordance with a user's instruction or the like. For instance, if the camera information and the microphone information can be transmitted in a form of video communication using the Skype system, convenience of the recording and reproducing apparatus 1 can be largely enhanced.

Note that the Skype system has large advantages over the conventional Internet telephone or the like, which includes (1) even if the number of users increases, the service load does not become heavy, and it can be used at free, (2) it can be used even if a firewall or an address conversion device (such as a BB router) exists between the Internet and an intranet or a home network, and (3) sound quality in conversation is better than that of existing telephone. These advantages are realized by processing various functions such as communication between users by the peer to peer (P2P) technology.

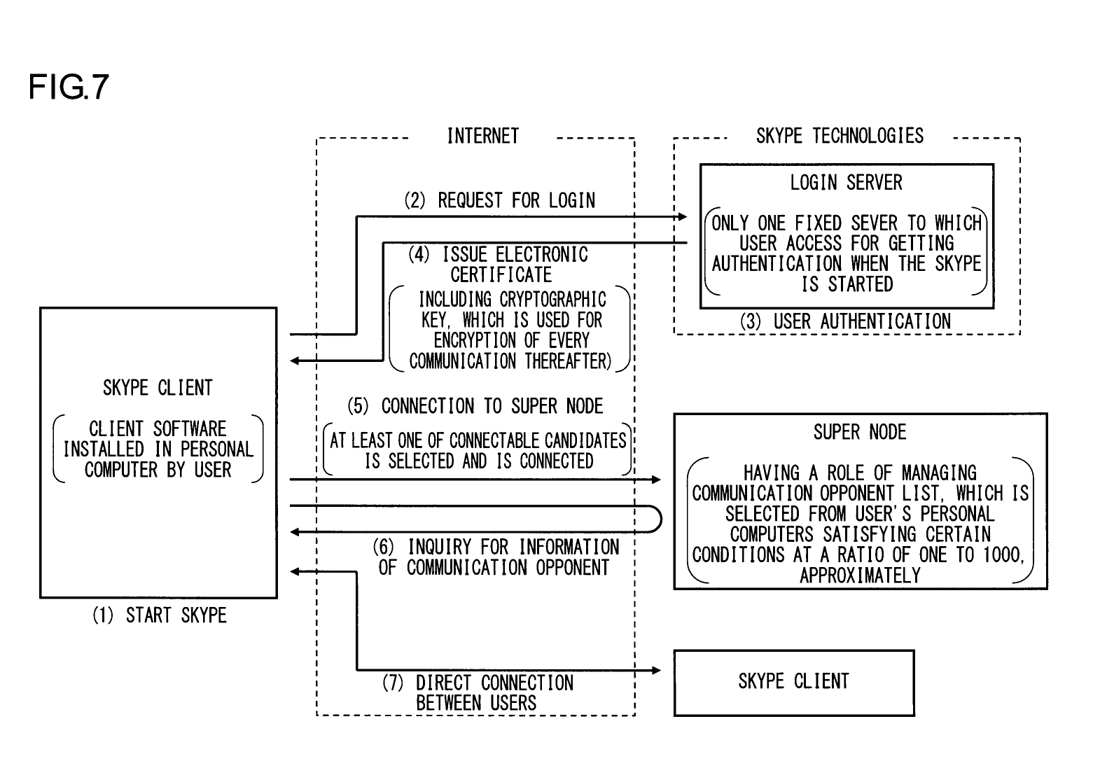

In addition, there are three elements constituting the service of the Skype system, which include a Skype client, a login server, and a super node as illustrated in FIG. 7. The Skype client is dedicated software that user installs in his or her personal computer. By installing this, functions of sound conversation, chatting, file transfer, and presence can be used.

The login server is a server for accepting a request for login from a Skype client and for authenticating the user. Only this login server is always installed at the same place. The login server also has a role to give a cryptographic key to the Skype client that is authenticated for safe communication with other clients.

The super node is a central entity of the Skype service that has various roles including “management of a communication opponent list”, “call other party”, and “sound relay”. The substantial entity thereof is a user's Skype client on the Internet. Among client personal computers working as Skype clients, the personal computers which satisfy conditions including to have a global IP address, to have sufficient process ability and line speed, to work stably for long hours, and the like, are arbitrarily selected as super nodes.

Other Skype client, after login, selects at least one of the super nodes for connection. After that, the connection to the super node is maintained continuously while inquiry for information of the communication opponent is issued as necessary.

[Others]

As described above, the recording and reproducing apparatus 1 includes the camera 13 and the microphone 14, so as to record camera information (video information) obtained by the camera 13 and microphone information (sound information) obtained by the microphone 14 as message information.

Further, the recording and reproducing apparatus 1 includes a functional unit (reproducing unit) which reproduces the message information, a functional unit (designated time receiving unit) which receives designation of scheduled playback time, and a functional unit (person distinguishing unit) which distinguishes presence or absence of a person in the vicinity of the apparatus. This reproducing unit performs the reproduction in accordance with the scheduled playback time and the distinction result of the person distinguishing unit. More specifically, when the present time has reached the scheduled playback time, and if it is decided that there is a person, the reproduction is performed.

Note that both the camera information and the microphone information are used as the message information in this embodiment, but it is possible to use one of them as the message information. In this case, one of the camera 13 and the microphone 14 may be eliminated.

In addition, the method of using video obtained by the camera 13 and the method based on presence or absence of operation by the operation unit 22 are used as the method for distinguishing presence or absence of a person in the vicinity of the apparatus in this embodiment, but it is possible to use other method (such as various known methods for detecting a person).

As described above, an embodiment of the present invention is disclosed, but the present invention is not limited to this embodiment. In addition, the embodiment of the present invention may be modified variously without deviating from the spirit of the present invention. According to the recording and reproducing apparatus of the present invention, reproduction of the message information can be performed at designated time and in accordance with presence or absence of a person.

What is claimed is:

1. A recording and reproducing apparatus comprising:
at least one of a camera and a microphone, so as to record at least one of video information obtained by the camera and sound information obtained by the microphone, as message information;
a reproducing unit which reproduces the message information;
a designated time receiving unit which receives designation of time; and
a person distinguishing unit which distinguishes presence or absence of a person, wherein
the reproducing unit performs the reproduction in accordance with the designated time, and a distinction result of the person distinguishing unit.

2. A recording and reproducing apparatus according to claim 1, wherein the reproducing unit performs the reproduction when the present time has reached the designated time and if it is decided that there is a person.

3. A recording and reproducing apparatus according to claim 2, wherein the reproducing unit does not perform the reproduction until it is decided that there is a person even if the present time has reached the designated time.

4. A recording and reproducing apparatus according to claim 1, wherein
the camera is provided for recording the video information as the message information, and
the person distinguishing unit distinguishes presence or absence of a person using video obtained by the camera.

5. A recording and reproducing apparatus according to claim 1, wherein
an operation unit is provided for receiving an operation by a user, and
the person distinguishing unit decides that there is a person when the operation is performed.

6. A recording and reproducing apparatus according to claim 2, comprising:
both the camera and the microphone for recording both the video information and the sound information as the message information;
a receiving unit which receives television broadcasting containing time information indicating the present time;
a display unit which is used for reproduction of the video information and for video display of the television broadcasting; and
a speaker which is used for reproduction of the sound information and for sound output of the television broadcasting, wherein
the reproducing unit grasps the present time based on the time information.

7. A recording and reproducing apparatus according to claim 6, wherein the person distinguishing unit uses video obtained by the camera for distinguishing presence or absence of a person.

8. A recording and reproducing apparatus according to claim 6, wherein
an operation unit is provided for receiving an operation by a user, and
the person distinguishing unit decides that there is a person when the operation is performed.

9. A recording and reproducing apparatus according to claim 1, wherein at least one of the video information and the sound information is transmitted using a communication system.

10. A recording and reproducing apparatus according to claim 9, wherein the communication system is a Skype™ system.
